(19) United States
(12) Patent Application Publication
(10) Pub. No.: US 2010/0161790 A1
(43) Pub. Date: Jun. 24, 2010

(54) Lawful Intercept for Multiple Simultaneous Broadband Sessions

(76) Inventor: Scott Sheppard, Decatur, GA (US)

Correspondence Address: AT&T Legal Department - HBH;Attn: Patent Docketing, One AT&T Way, Room 2A-207, Bedminster, NJ, 07921, US

(21) Appl. No.: 12/342,811

(22) Filed: Dec. 23, 2008

(51) Int. Cl. G06F 15/16

(52) U.S. Cl. 709/224

(57) ABSTRACT

Identifying information associated with a user under surveillance is received. A first intercept is provisioned on a first network element to intercept the data traffic according to the identifying information. A database is queried based on a login identifier associated with the user. A query result is received from the database. The query result may include a network element identifier and circuit information associate with the login identifier. A determination is made as to whether the network element identifier contained in the query result is the same as a network element identifier contained in information of record. In response to determining that the network element identifier contained in the query result is different from the network element identifier contained in the information of record, a second intercept is provisioned on a second network element to intercept the data traffic according to the network element identifier contained in the query result.

### BACKGROUND

Exemplary embodiments relate generally to the field of lawful interception, and more specifically, to lawfully intercepting data traffic from simultaneous sessions.

Lawful interception (e.g., wiretapping) is a common technique used by law enforcement agencies (“LEAs”) to intercept certain communications between parties of interest. Unlike illegal interception, lawful interception is performed in accordance with applicable (e.g., local, state and/or federal) laws. In particular, the communications that are intercepted under lawful interception may be subject to the limitations of due process and other legal considerations (e.g., Fourth Amendment). To further protect the parties of interest, intercepted communications may be authenticated to validate any claims in favor or against the evidence (e.g., that the intercepted communication originated from a particular party, that the communication was intercepted at a particular time).

Lawful interception is usually accomplished with the help and cooperation of a service provider. The duty of the service provider to provide LEAs with access to otherwise private communications is governed by the Communications Assistance for Law Enforcement Act (“CALEA”). As first passed by Congress in 1994, CALEA was primarily concerned with voice communications, such as plain old telephone service (“POTS”) and, more recently, voice over Internet protocol (“VOIP”). However, with the growth of the Internet, LEAs have also sought to intercept data communications transmitted over broadband networks. To this end, CALEA was recently expanded to cover data communications in addition to the traditional voice communications.

Lawful interception of data communications is generally facilities-based. For example, lawful interception may be performed at a network element, such as a broadband remote access server (“BRAS”) which can be directly associated with a subscriber's DSL service. The network element may be identified by a unique identifier (e.g., network access server (“NAS”) identifier (“ID”)), which is associated with a warrant for the user under surveillance. Thus, a network element identified by the appropriate unique identifier may be provisioned to intercept data traffic. The intercepted data traffic may then be provided to a mediation device.

A problem may arise when a user has two or more simultaneous network sessions at two or more separate facilities using the same login and password. For example, a user may log into a digital subscriber line (“DSL”) service at the home address of record using a given login and password. The user may then enter a coffee shop and utilize the coffee shop's WiFi service using the same login and password. In this example, the home address of record may be associated with a first BRAS, while the coffee shop is associated with a second BRAS. Thus, if only the first BRAS is provisioned to intercept data traffic, then only data traffic at the home address record will be intercepted, while data traffic at the coffee shop will not be intercepted.

### SUMMARY

Embodiments of the disclosure presented herein include methods, systems, and computer-readable media for lawfully intercepting data traffic from simultaneous sessions. According to one aspect, a method for lawfully intercepting data traffic from simultaneous sessions is provided. According to the method, identifying information associated with a user under surveillance is received. A first intercept is provisioned on a first network element to intercept the data traffic according to the identifying information. A database is queried based on a login identifier associated with the user. A query result is received from the database. The query result may include a network element identifier and circuit information associate with the login identifier. A determination is made as to whether the network element identifier contained in the query result is the same as a network element identifier contained in information of record. In response to determining that the network element identifier contained in the query result is different from the network element identifier contained in the information of record, a second intercept is provisioned on a second network element to intercept the data traffic according to the network element identifier contained in the query result.

Further, in response to determining that the network element identifier contained in the query result is the same as the network element identifier in the information of record, a determination is made as to whether the circuit information contained in the query result is the same as circuit information contained in the information of record. In response to determining that the circuit information contained in the query result is different from the circuit information contained in the information of record, the second intercept is provisioned on the first network element to intercept the data traffic according to the circuit information contained in the query result.

According to another aspect, a system for lawfully intercepting data traffic from simultaneous sessions is provided. The system includes a memory and a processor functionally coupled to the memory. The memory stores a program containing code for lawfully intercepting data traffic from simultaneous sessions. The processor is responsive to computer-executable instructions contained in the program and operative to perform the following operations. Identifying information associated with a user under surveillance is received. A first intercept is provisioned on a first network element to intercept the data traffic according to the identifying information. A database is queried based on a login identifier associated with the user. A query result is received from the database. The query result may include a network element identifier and circuit information associate with the login identifier. A determination is made as to whether the network element identifier contained in the query result is the same as a network element identifier contained in information of record. In response to determining that the network element identifier contained in the query result is different from the network element identifier contained in the information of record, a second intercept is provisioned on a second network element to intercept the data traffic according to the network element identifier contained in the query result.

Further, in response to determining that the network element identifier contained in the query result is the same as the network element identifier in the information of record, a determination is made as to whether the circuit information contained in the query result is the same as circuit information contained in the information of record. In response to determining that the circuit information contained in the query result is different from the circuit information contained in the information of record, the second intercept is provisioned on the first network element to intercept the data traffic according to the circuit information contained in the query result.

According to yet another aspect, a computer-readable medium having instructions stored thereon for execution by a processor to perform a method for lawfully intercepting data traffic from simultaneous sessions is provided. According to the method, identifying information associated with a user under surveillance is received. A first intercept is provisioned on a first network element to intercept the data traffic according to the identifying information. A database is queried based on a login identifier associated with the user. A query result is received from the database. The query result may include a network element identifier and circuit information associate with the login identifier. A determination is made as to whether the network element identifier contained in the query result is the same as a network element identifier contained in information of record. In response to determining that the network element identifier contained in the query result is different from the network element identifier contained in the information of record, a second intercept is provisioned on a second network element to intercept the data traffic according to the network element identifier contained in the query result.

Further, in response to determining that the network element identifier contained in the query result is the same as the network element identifier in the information of record, a determination is made as to whether the circuit information contained in the query result is the same as circuit information contained in the information of record. In response to determining that the circuit information contained in the query result is different from the circuit information contained in the information of record, the second intercept is provisioned on the first network element to intercept the data traffic according to the circuit information contained in the query result.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a diagram illustrating an interception system operative to lawfully intercept data traffic from simultaneous sessions, in accordance with exemplary embodiments.

FIGS. 2A and 2B are illustrative query results containing AAA data as a result of querying a RADIUS database, in accordance with exemplary embodiments.

FIG. 3 is a flow diagram illustrating a method for lawfully intercepting data traffic from simultaneous sessions, in accordance with exemplary embodiments.

FIG. 4 is a computer architecture diagram showing aspects of an illustrative computer hardware architecture for a computing system capable of implementing aspects of the embodiments presented herein.

### DETAILED DESCRIPTION

The following detailed description is directed to lawfully intercepting data traffic from simultaneous sessions. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

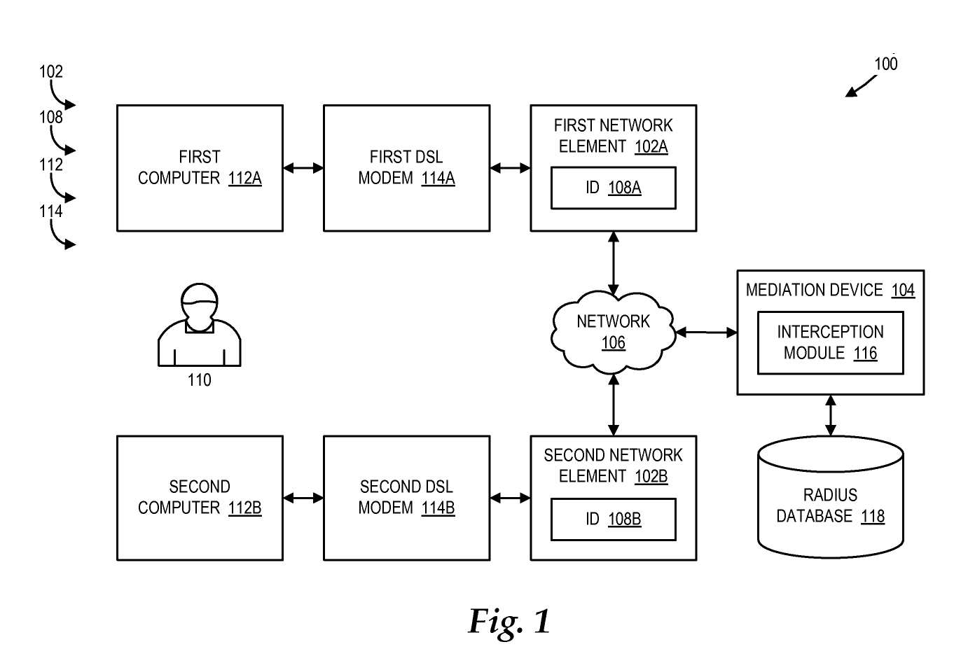

In the following detailed description, references are made to the accompanying drawings that form a part hereof, and which are shown by way of illustration, using specific embodiments or examples. Referring now to the drawings, in which like numerals represent like elements through the several figures, aspects of a computing system and methodology for lawfully intercepting data traffic from simultaneous sessions will be described. FIG. 1 shows an illustrative interception system 100 in accordance with exemplary embodiments. The system 100 includes a first network element 102A and a second network element 102B (collective referred to as network elements 102). The network elements 102 are operatively coupled to a mediation device 104 via a network 106, such as the Internet. The network elements 102 may include any suitable devices operative to transport data traffic across the network 106. Examples of the network elements 102 include, but are not limited to, a broadband remote access server (“BRAS”), router, and a network switch. Although not so limited and for the sake of simplicity, the embodiments described herein primarily refer to the network elements 102 as BRASs. However, it should be appreciated that the embodiments described herein may be similarly utilized for any suitable network element where subscriber data passes.

The network elements 102 may be associated with identifying information and capable of being provisioned to intercept data traffic. In one embodiment, the first network element 102A is associated with a first unique identifier 108A, and the second network element 102B is associated with a second unique identifier 108B. The first unique identifier 108A and the second unique identifier 108B (collectively referred to as unique identifiers 108) may be a network element identifier (“ID”) identifying a particular network element or a circuit ID identifying a particular circuit within the network element. Examples of the unique identifiers 108 include, but are not limited to, a network access server (“NAS”) ID, a user ID, an agent circuit ID, and a permanent virtual circuit (“PVC”).

As shown in FIG. 1, a user 110 under surveillance accesses a network, such as the Internet, through a first computer 112A and a first digital subscriber line (“DSL”) modem (i.e., an asynchronous digital subscribe line termination unit remote (“ATUR”)) 114A, which is operatively coupled to the first network element 102A. In particular, the user 110 may access the network 106 by entering a given login-password pair on the first computer 112A.

While the user 110 is logged into the network 106 through the first computer 112A, the user may also access the network 106 through a second computer 112B and a second DSL modem 114B, which is operatively coupled to the second network element 102B. As described in greater detail below, the user 110 may also access the network 106 through another circuit on the first network element 102A, according to further embodiments. In particular, the user 110 may access the network 106 by entering the same login-password pair on the second computer 112B. It should be appreciated that the first computer 112A and the second computer 112B (collective referred to as computers 112) may host a Point-to-Point Protocol over Ethernet client (“PPPoE”), eliminating the need for the first DSL modem 114A and the second DSL modem 114B (collectively referred to as DSL modems 114). Other suitable network access configurations may also be utilized as contemplated by those skilled in the art.

In one embodiment, the first unique identifier 108A is associated with the user 110 under surveillance, while the second unique identifier 108B is not associated with the user 110 under surveillance. For example, the first unique identifier 108A may be associated with the user's 110 information of record contained in a law enforcement agency (“LEA”) warrant. The information of record may include, among other relevant information, the login ID of the user, the address of the user, and the Internet Protocol (“IP”) address of the user. The second unique identifier 108B may not be associated with the user's 110 information of record. For example, the user 110 may access the second network element 102B through a publicly accessible hotspot that is not contained in the LEA warrant.

Because only the first unique identifier 108A is associated with the user 110, it follows that a service provider only has knowledge to provision the first network element 102A to intercept data traffic, which is forwarded by the first network element 102A to the mediation device 104. The service provider may be entirely unaware of the second network element 102B, potentially causing a significant loophole where the data traffic passing through the second network element 102B is not intercepted.

In order to address this loophole, the mediation device 104 includes an interception module 116, in accordance with exemplary embodiments. The interception module 116 may be embodied in hardware, firmware, software, or combinations thereof. In one embodiment, the interception module 116 is operative to retrieve relevant Authentication, Authorization and Accounting (“AAA”) information by querying information from a Remote Authentication Dial In User Service (“RADIUS”) database 118. For example, the interception module 116 may query the RADIUS database 118 using the login ID of the user 110 in order to retrieve AAA information associated with the login ID.

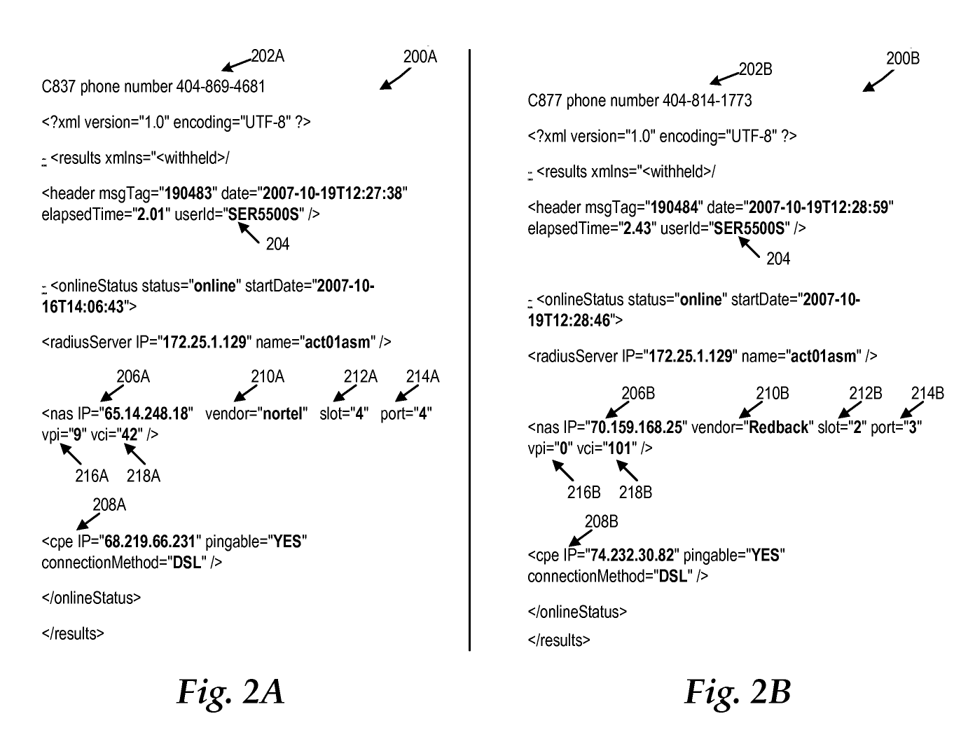

Referring now to FIGS. 2A to 2B, illustrative query results 200A, 200B from the RADIUS database 118 are shown. In the example described above, the interception module 116 may send a query containing the login ID of the user 110 to the RADIUS database 118. Upon receiving the query, the RADIUS database 118 returns to the interception module 116 the query results 200A, 200B.

In FIG. 2A, the first query result 200A is associated with a first telephone number 202A “404-869-4681” accessed by the login ID 204, “SER5500S”, of the user 110. The first query result 200A includes a NAS IP address 206A associated with the first network element 102A, a customer premises equipment (“CPE”) IP address 208A (i.e., the IP address of the first computer 112A). The first query result 200A further indicates that the first computer 112A is connected to a slot 212A (i.e., slot 4), a port 214A (i.e., port 4), a virtual path identifier (“VPI”) 216A (i.e., VPI 9), and a virtual channel identifier (“VCI”) 218A (i.e., VCI 42).

In the example of FIG. 2A, the first telephone number 202A is the home telephone number of the user 110. Thus, the service provider may have previously provisioned the first network element 102A to intercept data traffic as this was the facility of record for the subscriber to access the network. In particular, the first network element 102A may have been provisioned to intercept data traffic based on one or more of the NAS IP address 206A, the CPE IP address 208A, the slot 212A, the port 214A, the VPI 216A, and/or the VCI 218A. Thus, the AAA information contained in the first query result 200A will match the information of record associated with the user 110.

In FIG. 2B, the second query result 200B is associated with a second telephone number 202B “404-814-1773” accessed by the login ID 204 of the user 110. The second query result 200B includes a NAS IP address 206B associated with the second network element 102B, a CPE IP address 208B (i.e., the IP address of the second computer 112B), and a device type 210B of the second network element 102B. The second query result 200B further indicates that the second computer 112B is connected to a slot 212B (i.e., slot 2), a port 214B (i.e., port 3), a VPI 216B (i.e., VPI 0), and a VCI 218B (i.e., VCI 101).

In the example of FIG. 2B, the second telephone number 202B is different telephone number than the home telephone number of record. Thus, the interception module 116 will not recognize the slot 212B, the port 214B, the VPI 216B, or the VCI 218B contained in the second query result 200B.

Referring again to FIG. 1, in response to discovering this new AAA information contained in the second query result 200B, the interception module 116 may provision the second network element 102B based on the new AAA information. For example, the interception module 116 may provision the second network element 102B associated with the NAS IP address 206B to intercept data traffic and to forward the intercepted data traffic to the mediation device 104. In this way, although the user 110 may be accessing the network 106 through simultaneous sessions, the service provider is able to intercept data traffic at both of the network elements 102. In particular, the service provider is able to intercept data traffic at the second network element 102B which is not associated with the information of record.

Embodiments described herein primarily describe the application of the interception module 116 to the example illustrated in FIG. 1 containing the separate network elements 102. It should be appreciated, however, that the application of the interception module 116 on this example is not intended to be limiting. In particular, the interception module 116 may also be applied to the situation where the user 110 accesses different circuits on the same network element. For example, the second DSL modem 114B may be operatively coupled to the first network element 102A. In this case, the first computer 112A may access the network 106 through one circuit on the first network element 102A, and the second computer 112B may access the network 106 through another circuit on the first network element 102B.

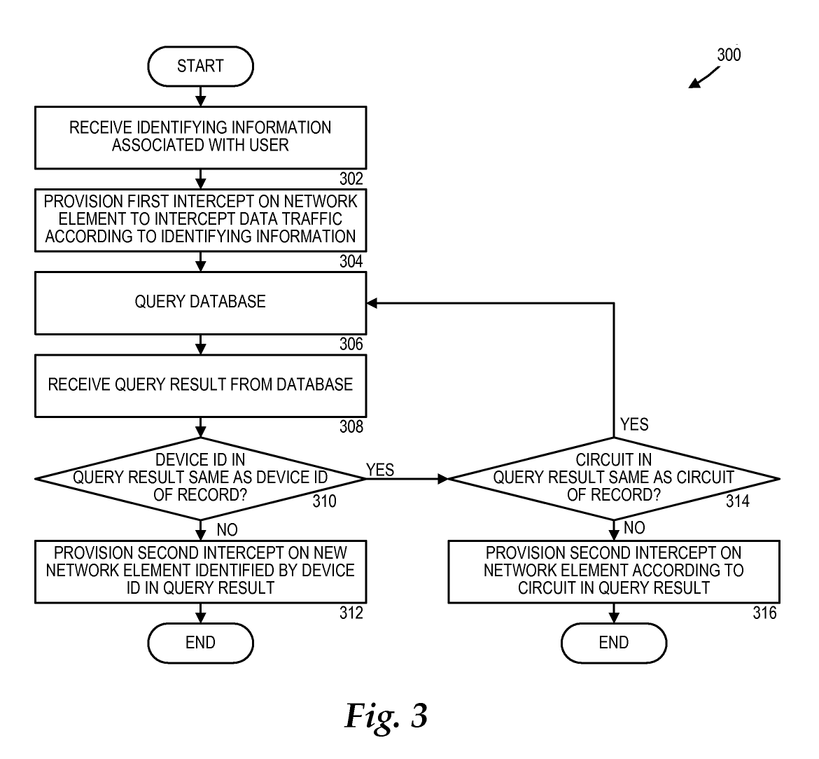

Referring now to FIG. 3, additional details will be provided regarding the embodiments presented herein for lawfully intercepting data traffic from simultaneous sessions. In particular, FIG. 3 is a flow diagram illustrating one method for lawfully intercepting data traffic from simultaneous sessions. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In a routine 300, the interception module 116 receives (at 302) identifying information associated with the user 110. Examples of the identifying information include, but is not limited to, the login ID 204, the NAS IP address 206A, 206B, the CPE IP address 208A, 208B, the agent circuit ID, the PVC, and the like.

After receiving the identifying information, the interception module 116 provisions (at 304) a first intercept on a network element, such as the first network element 102A, to intercept data traffic according to the identifying information. For example, the interception module 116 may identify the first network element 102A by its corresponding NAS IP address 206A. In other examples, the interception module 116 may provision the first network element 102A based on the login ID 204, the CPE IP address 208A, 208B, the agent circuit ID, the PVC, and the like.

After the first network element 102A is provisioned, the first network element 102A intercepts data traffic and forwards the intercepted data traffic to the mediation device 104. In order to verify that the user 110 is not accessing the network 106 through another network element, such as the second network element 102B, or another circuit within the first network element 102A, the interception module 116 queries (at 306) a database, such as the RADIUS database 118. In one embodiment, the interception module 116 queries the RADIUS database 118 based on the login ID 204. After providing the login ID 204 to the RADIUS database 118, the interception module 116 receives (at 308) a query result, such as the query results 200A, 200B, containing AAA information associated with the login ID 204.

After receiving the query result from the RADIUS database 118, the interception module 116 compares (at 310) a network element identifier, such as the NAS IP address 206A, 206B, contained in the query result to the network element identifier contained in the information of record. If the network element identifier contained in the query result does not match the network element identifier contained in the information of record, then the interception module 116 provisions (at 312) a second intercept on a new network element, such as the second network element 102B, identified by the network element identifier contained in the query result. In particular, the interception module 116 may provision the new network element according to the network element identifier and the circuit information (e.g., the agent circuit ID, the PVC, etc.) contained in the query result. If a RADIUS session end message is observed, the interception 116 module may de-provision any existing intercepts as they are no longer needed.

If the network element identifier contained in the query result matches the network element identifier contained in the information of record, then the interception module 116 compares (at 314) the circuit information (e.g., the agent circuit ID, the PVC, etc.) contained in the query result to the circuit information contained in the information of record. If the circuit information contained in the query result does not match the circuit information contained in the information of record, then the interception module 116 provisions (at 316) a second intercept on the network element, such as the first network element 102A, according to the circuit information contained in the query result. If the circuit information contained in the query result matches the circuit information contained in the information of record, then the interception module 116 concludes that no simultaneous sessions are present, and the network element continues to intercept data traffic as it was originally provisioned. The interception module 116 may also continue to determine any simultaneous sessions by again querying (at 306) the database

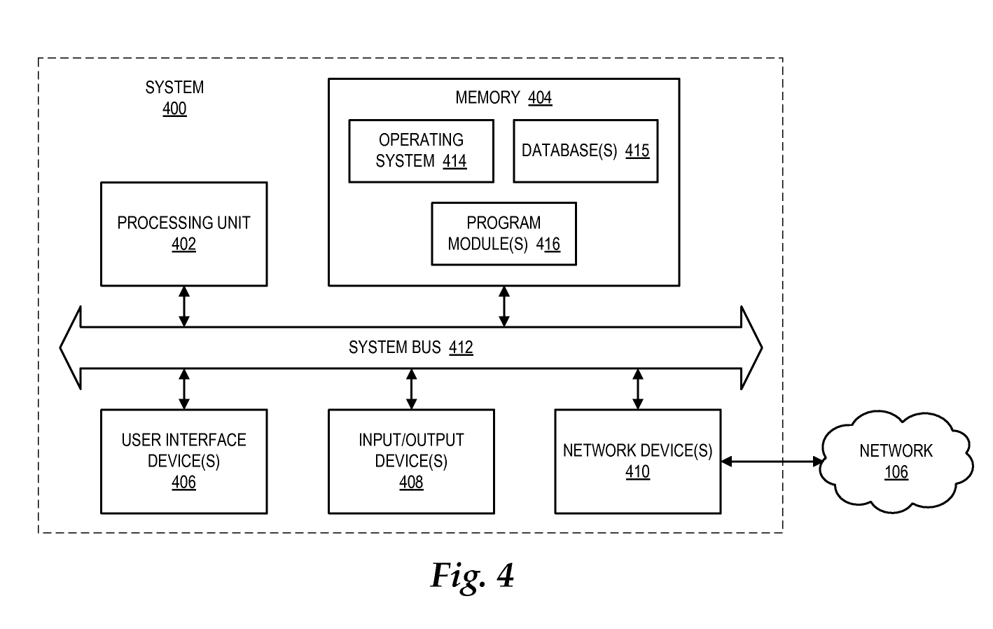

FIG. 4 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 4 is a block diagram illustrating a system 400 operative to lawfully intercept data traffic from simultaneous sessions, in accordance with exemplary embodiments. The system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410. Examples of the system 400 include, but are not limited to, computers, servers, personal digital assistants, cellular phones, or any suitable computing devices.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 404 communicates with the processing unit 402 via the system bus 412. In one embodiment, the memory 404 is operatively connected to a memory controller (not shown) that enables communication with the processing unit 402 via the system bus 412. The memory 404 includes an operating system 414, one or more databases 415, and one or more program modules 416, according to exemplary embodiments. An example of the program modules 416 is the interception module 116. In one embodiment, the method 300 as described above with respect to FIG. 3 is embodied as a program module in the memory 404 and executed by the system 400. Examples of operating systems, such as the operating system 414, include, but are not limited to, WINDOWS and WINDOWS MOBILE operating systems from MICROSOFT CORPORATION, MAC OS operating system from APPLE CORPORATION, LINUX operating system, SYMBIAN OS from SYMBIAN SOFTWARE LIMITED, BREW from QUALCOMM INCORPORATED, and FREEBSD operating system.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the system 400.

The user interface devices 406 may include one or more devices with which a user accesses the system 400. The user interface devices 406 may include, but are not limited to, computers, servers, personal digital assistants, cellular phones, or any suitable computing devices. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer.

The network devices 410 enable the system 400 to communicate with other networks or remote systems via a network, such as the network 106. Examples of network devices 410 may include, but are not limited to, a modem, a radio frequency (“RF”) or infrared (“IR”) transceiver, a telephonic interface, a bridge, a router, or a network card. The network 418 may include a wireless network such as, but not limited to, a Wireless Local Area Network (“WLAN”) such as a WI-FL network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 418 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A computer-implemented method for lawfully intercepting data traffic from simultaneous sessions, the method comprising:
receiving identifying information associated with a user under surveillance;
provisioning a first intercept on a first network element to intercept the data traffic according to the identifying information;
querying a database based on a login identifier associated with the user;
receiving a query result from the database, the query result comprising a network element identifier and circuit information associate with the login identifier;
determining whether the network element identifier contained in the query result is the same as a network element identifier contained in information of record; and
in response to determining that the network element identifier contained in the query result is different from the network element identifier contained in the information of record, provisioning a second intercept on a second network element to intercept the data traffic according to the network element identifier contained in the query result.

2. The computer-implemented method of claim 1, the method further comprising:
in response to determining that the network element identifier contained in the query result is the same as the network element identifier in the information of record, determining whether the circuit information contained in the query result is the same as circuit information contained in the information of record; and
in response to determining that the circuit information contained in the query result is different from the circuit information contained in the information of record, provisioning the second intercept on the first network element to intercept the data traffic according to the circuit information contained in the query result.

3. The method of claim 1, wherein the identifying information comprises the login identifier, a broadband remote access server (BRAS) identifier, agent circuit identifier, or a private virtual circuit (PVC).

4. The method of claim 1, wherein the first network element and the second network element comprise a broadband remote access server (BRAS), a router, or a network switch.

5. The method of claim 1, wherein the database comprises a Remote Authentication Dial In User Service (RADIUS) database; and wherein the query result comprises Authentication, Authorization and Accounting (AAA) information.

6. The method of claim 1, wherein the network element identifier comprises a broadband remote access server (BRAS) identifier, a router identifier, or a network switch identifier.

7. The method of claim 1, wherein the circuit information comprises an agent circuit identifier or a private virtual circuit (PVC).

8. A system for lawfully intercepting data traffic from simultaneous sessions, comprising:
a memory for storing a program for lawfully intercepting data traffic from simultaneous sessions; and
a processor functionally coupled to the memory, the processor being responsive to computer-executable instructions contained in the program and operative to:
receive identifying information associated with a user under surveillance,
provision a first intercept on a first network element to intercept the data traffic according to the identifying information,
query a database based on a login identifier associated with the user;
receive a query result from the database, the query result comprising a network element identifier and circuit information associate with the login identifier,
determine whether the network element identifier contained in the query result is the same as a network element identifier contained in information of record, and
in response to determining that the network element identifier contained in the query result is different from the network element identifier contained in the information of record, provision the second intercept on a second network element to intercept the data traffic according to the network element identifier contained in the query result.

9. The system of claim 8, the processor being responsive to further computer-executable instructions contained in the program and operative to:
in response to determining that the network element identifier contained in the query result is the same as the network element identifier in the information of record, determine whether the circuit information contained in the query result is the same as circuit information contained in the information of record, and
in response to determining that the circuit information contained in the query result is different from the circuit information contained in the information of record, provision a second intercept on the first network element to intercept the data traffic according to the circuit information contained in the query result.

10. The system of claim 8, wherein the identifying information comprises the login identifier, a broadband remote access server (BRAS) identifier, agent circuit identifier, or a private virtual circuit (PVC).

11. The system of claim 8, wherein the first network element and the second network element comprise a broadband remote access server (BRAS), a router, or a network switch.

12. The system of claim 8, wherein the database comprises a Remote Authentication Dial In User Service (RADIUS) database; and wherein the query result comprises Authentication, Authorization and Accounting (AAA) information.

13. The system of claim 8, wherein the network element identifier comprises a broadband remote access server (BRAS) identifier, a router identifier, or a network switch identifier.

14. A computer-readable medium having instructions stored thereon for execution by a processor to provide a method for lawfully intercepting data traffic from simultaneous sessions, the method comprising:
receiving identifying information associated with a user under surveillance;
provisioning a first intercept on a first network element to intercept the data traffic according to the identifying information;
querying a database based on a login identifier associated with the user;
receiving a query result from the database, the query result comprising a network element identifier and circuit information associate with the login identifier;
determining whether the network element identifier contained in the query result is the same as a network element identifier contained in information of record; and
in response to determining that the network element identifier contained in the query result is different from the network element identifier contained in the information of record, provisioning a second intercept on a second network element to intercept the data traffic according to the network element identifier contained in the query result.

15. The computer-readable medium of claim 14, the method further comprising:
in response to determining that the network element identifier contained in the query result is the same as the network element identifier in the information of record, determining whether the circuit information contained in the query result is the same as circuit information contained in the information of record; and
in response to determining that the circuit information contained in the query result is different from the circuit information contained in the information of record, provisioning the second intercept on the first network element to intercept the data traffic according to the circuit information contained in the query result.

16. The computer-readable medium of claim 14, wherein the identifying information comprises the login identifier, a broadband remote access server (BRAS) identifier, agent circuit identifier, or a private virtual circuit (PVC).

17. The computer-readable medium of claim 14, wherein the first network element and the second network element comprise a broadband remote access server (BRAS), a router, or a network switch.

18. The computer-readable medium of claim 14, wherein the database comprises a Remote Authentication Dial In User Service (RADIUS) database; and wherein the query result comprises Authentication, Authorization and Accounting (AAA) information.

19. The computer-readable medium of claim 14, wherein the network element identifier comprises a broadband remote access server (BRAS) identifier, a router identifier, or a network switch identifier.

20. The computer-readable medium of claim 14, wherein the circuit information comprises an agent circuit identifier or a private virtual circuit (PVC).
